(19) United States
(12) Patent Application Publication
(10) Pub. No.: US 2026/0268668 A1
(43) Pub. Date: Sep. 10, 2026

(54) VIDEO PROCESSING

(71) Applicant: British Telecommunications Public Limited Company, London, Greater London (GB)

(72) Inventors: Ian NEILD, London (GB); David WILKS, London (GB); Andrew REEVES, London (GB); Michael NILSSON, London (GB)

(21) Appl. No.: 19/164,617

(22) PCT Filed: Feb. 8, 2024
(86) PCT No.: PCT/EP2024/053137

§ 371 Date: Sep. 12, 2025

(30) Foreign Application Priority Data
Mar. 16, 2023 (EP) 23162463.6
Mar. 16, 2023 (GB) 2303867.2

(51) Int. Cl. G06V 20/40; G06V 10/25; G06V 10/74; G06V 20/13; G06V 20/17; G06V 20/54; G06V 20/56; H04N 7/18

(52) U.S. Cl. CPC G06V 20/46; G06V 10/25; G06V 10/761; G06V 20/13; G06V 20/17; G06V 20/56; H04N 7/185; G06V 20/54

(57) ABSTRACT

A computer-implemented method of processing a video stream is provided together with a computer system and computer program for doing the same. The video stream is captured from a video sensor mounted on a mobile entity during a journey. The method comprises, for each frame of the video stream: determining a respective measure of changeability for one or more regions of the frame based on a plurality of reference frames, each of the plurality of reference frames being a previously captured frame covering substantially the same view as the frame; determining a respective measure of change for each of the one or more regions of the frame, the measure of change being determined based on the frame and at least one of the reference frames; determining a respective measure of interest for each of the one or more regions of the frame, the respective measure of interest being based on the respective measure of change and the respective measure of changeability for that frame; and processing the video stream based on the determined measures of interest for each frame to generate a processed video stream.

### FIELD OF THE INVENTION

The present invention relates to video processing. In particular, the present invention relates to processing a video stream captured from a video sensor mounted on a vehicle during a journey.

### BACKGROUND TO THE INVENTION

The use of drones to carry out various tasks has been expanding in recent years driven, at least in part, by increases in drone capabilities as well as reductions in their costs. One such use is in carrying out surveys of large geographic areas for a range of purposes. The use of drones to carry out surveys generally enables surveys to be carried out more quickly and cost-effectively. As a result, surveys may be performed more regularly. Regular surveys can allow the geographic area being surveyed to be monitored over a period of time, for example, to watch for any changes occurring within the geographic area that may require further investigation or action.

To carry out a survey, a drone is typically equipped with one or more imaging sensors to capture images of the geographic area. The drone may then be flown through the geographic area using the imaging sensors to capture images at regular intervals as it travels on its journey. Each of the imaging sensors produces a respective video stream (i.e. sequence of images) for the drone's journey through the geographic area. Commonly such drones will include a photographic sensor (or video camera) that captures a sequence of photographic images as a video stream that is substantially the same as would be viewed by the human eye. However, other types of imaging sensors, such as thermal imaging sensors, night vision sensors, sonar imaging sensors, radar imaging sensors, and/or lidar imaging sensors, may be used in addition or as an alternative to a photographic sensor to capture sequences of images (or video streams) that convey other information about the geographic area that may differ from that which would be viewed by the human eye.

### SUMMARY OF THE INVENTION

A large amount of data can be produced by the respective video streams from the sensors on drones when carrying out surveys. At the same time, drones may have limited data transmission and/or storage available for making the results of the survey available to an operator. Meanwhile, it has been recognised by the inventors that it is generally the case that only some of the data that is captured will be of relevance (i.e. in meeting the aims of the survey). This may be especially true for repeated surveys of the same geographic area over time in which the majority of the captured data may be substantially duplicative. Accordingly, it would be desirable to provide a technique that reduces the amount of data that is needed to be stored and/or transmitted whilst preserving the usefulness of the survey data that is provided.

In a first aspect of the invention, there is provided a computer-implemented method of processing a video stream captured from a video sensor mounted on a mobile entity during a journey, the method comprising, for each frame of the video stream: determining a respective measure of changeability for one or more regions of the frame based on a plurality of reference frames, each of the plurality of reference frames being a previously captured frame covering substantially the same view as the frame; determining a respective measure of change for each of the one or more regions of the frame, the measure of change being determined based on the frame and at least one of the reference frames; determining a respective measure of interest for each of the one or more regions of the frame, the respective measure of interest being based on the respective measure of change and the respective measure of changeability for that frame; and processing the video stream based on the determined measures of interest for each frame to generate a processed video stream.

Through the use of previously captured frames that have captured the same view as that currently being captured (but at earlier points in time) as references, the invention generates knowledge as to the significance of changes in different regions of the frame (as well as in different frames of a video stream). This knowledge allows the relevance of each part of the video stream to be determined and a processed video stream to be produced based on this knowledge.

Processing the video stream may comprise, for each frame of the video stream: determining whether the respective measures of interest for any of the one or more regions of that frame exceeds a predetermined threshold; and dropping that frame from the processed video stream in response to determining that none of the respective measures of interest for the one or more regions of the frame exceeds the predetermined threshold.

Processing the video stream comprises, for each frame of the video stream: determining whether the respective measure of interest for each of the one or more regions of the frame exceeds a predetermined threshold; and in response to determining that the respective measure of interest for a region of the frame does not exceed the predetermined threshold, dropping that region of the frame, such that the corresponding frame of the processed video stream only comprises those regions of the frame for which the respective measure of interest exceeds the predetermined threshold.

The method may further comprise: generating, for each region of the frame for which the respective measure of interest does not exceed the predetermined threshold, respective reconstruction data for reconstructing a representation of that region of the frame from the plurality of reference frames; and providing the respective reconstruction data with the processed video stream.

Processing the video stream further comprises, for each frame of the video stream, in response to determining that the respective measure of interest for a region of the frame exceeds the predetermined threshold: generating respective reconstruction data for reconstructing a representation of that region of the frame from the plurality of reference frames; determining a difference image for that region of the frame representing the difference between that region of the frame and the representation of that region of the frame provided by the reconstruction data; substituting that region of the frame in the processed video stream with the difference image; and providing the respective reconstruction data with the processed video stream.

The frame reconstruction data may comprises an indication of one of the reference frames for which the corresponding region most closely matches that region of the frame.

The frame reconstruction data may indicate a combination of at least two reference frames.

The method may further comprise storing the processed video stream on a storage onboard the mobile entity.

The method may further comprise transmitting the processed video stream to a remote receiver.

The mobile entity may be a vehicle. The vehicle may be an unmanned aerial vehicle. The mobile entity may be a satellite.

The journey may be undertaken as part of a survey of a geographical area and preferably one or more, or all, of the reference frames may each be associated with a respective video stream that was captured from a previous survey of the geographical area.

In a second aspect of the invention, there is provided a computer-implemented method of processing a plurality of video streams, each video stream being contemporaneously captured from a respective video sensor mounted on a mobile entity, the method comprising: processing each of the plurality of video streams according to the method of the first aspect; and producing, as the processed video stream for the plurality of video streams, a consolidated video stream from the plurality of video streams by selecting, for each frame of the consolidated video stream, a single frame from contemporaneously captured frames of the plurality of video streams based on the respective measures of interest for each of those frames.

Through the application of a method according to the first aspect to multiple video streams that are contemporaneously captured from the same vehicle, a relative significance of each video stream can be determined on a frame-by-frame basis allowing a single consolidated video stream to be produced that provides the most relevant frame from amongst the multiple video streams at each point in time.

The method may further comprise storing the processed video stream on a storage onboard the mobile entity.

The method may further comprise transmitting the processed video stream to a remote receiver.

The mobile entity may be a vehicle. The vehicle may be an unmanned aerial vehicle. The mobile entity may be a satellite.

The journey may be undertaken as part of a survey of a geographical area and preferably one or more, or all, of the reference frames may each be associated with a respective video stream that was captured from a previous survey of the geographical area.

In a third aspect of the invention, there is provided a computer system comprising a processor and a memory storing computer program code for performing a method according to either the first or the second aspects.

In a fourth aspect of the invention, there is provided a computer program which, when executed by one or more processors is arranged to carry out a method according to either the first or the second aspects.

### BRIEF DESCRIPTION OF THE FIGURES

Embodiments of the present invention will now be described by way of example only, with reference to the accompanying drawings, in which:

FIG. 1 is a block diagram of a computer system suitable for the operation of embodiments of the present invention;

FIG. 2 is a diagrammatic representation of an exemplary scenario in which embodiments of the invention may be used;

FIG. 3 is a diagrammatic representation of an exemplary frame of a video stream to be processed by embodiments of the invention;

FIG. 4 is a flowchart illustrating a computer-implemented method of processing a video stream captured from a video sensor mounted on a vehicle during a journey according to embodiments of the invention;

FIGS. 5A, 5B and 5C are diagrammatic representations of exemplary reference frames for use by embodiments of the invention;

FIG. 6 is a diagrammatic representation of a processed frame according to some embodiments of the invention; and

FIG. 7 is a diagrammatic representation of another processed frame according to some embodiments of the invention.

### DETAILED DESCRIPTION OF EMBODIMENTS

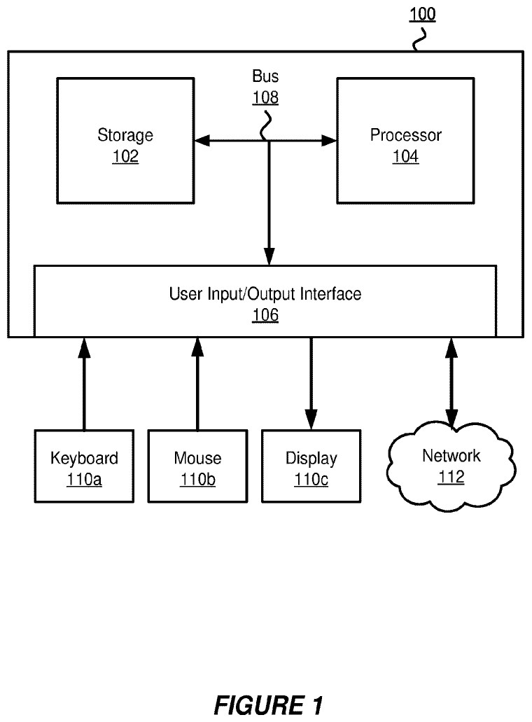

FIG. 1 is a block diagram of a computer system 100 suitable for the operation of embodiments of the present invention. The system 100 comprises: a storage 102, a processor 104 and an input/output (I/O) interface 106, which are all communicatively linked over one or more communication buses 108.

The storage (or storage medium or memory) 102 can be any volatile read/write storage device such as a random access memory (RAM) or a non-volatile storage device such as a hard disk drive, magnetic disc, optical disc, ROM and so on. The storage 102 can be formed as a hierarchy of a plurality of different storage devices, including both volatile and non-volatile storage devices, with the different storage devices in the hierarchy providing differing capacities and response times, as is well known in the art.

The processor 104 may be any processing unit, such as a central processing unit (CPU), which is suitable for executing one or more computer programs (or software or instructions or code). These computer programs may be stored in the storage 102. During operation of the system, the computer programs may be provided from the storage 102 to the processor 104 via the one or more buses 108 for execution. One or more of the stored computer programs, when executed by the processor 104, cause the processor 104 to carry out a method according to an embodiment of the invention, as discussed below (and accordingly configure the system 100 to be a system 100 according to an embodiment of the invention). The input/output (I/O) interface 106 provides interfaces to devices 110 for the input or output of data, or for both the input and output of data. The devices 110 may include user input interfaces, such as a keyboard 110a or mouse 110b as well as user output interfaces such as a display 110c. Other devices, such a touch screen monitor (not shown) may provide means for both inputting and outputting data. The input/output (I/O) interface 106 may additionally or alternatively enable the computer system 100 to communicate with other computer systems via one or more networks 112. It will be appreciated that there are many different types of I/O interface that may be used with computer system 100 and that, in some cases, computer system 100 may include more than one I/O interface. Furthermore, there are many different types of device 100 that may be used with computer system 100. The devices 110 that interface with the computer system 100 may vary considerably depending on the nature of the computer system 100 and may include devices not explicitly mentioned above, as would be apparent to the skilled person. For example, in some cases, computer system 100 may be a server without any connected user input/output devices. Such a server may receive data via a network 112, carry out processing according to the received data and provide the results of the processing via a network 112.

It will be appreciated that the architecture of the system 100 illustrated in FIG. 1 and described above is merely exemplary and that other computer systems 100 with different architectures (such as those having fewer components, additional components and/or alternative components to those shown in FIG. 1) may be used in embodiments of the invention. As examples, the computer system 100 could comprise one or more of: an onboard computer system on a vehicle, a personal computer; a laptop; a tablet; a mobile telephone (or smartphone); an augmented/virtual reality headset; a server; or indeed any other computing device with sufficient computing resources to carry out a method according to embodiments of this invention.

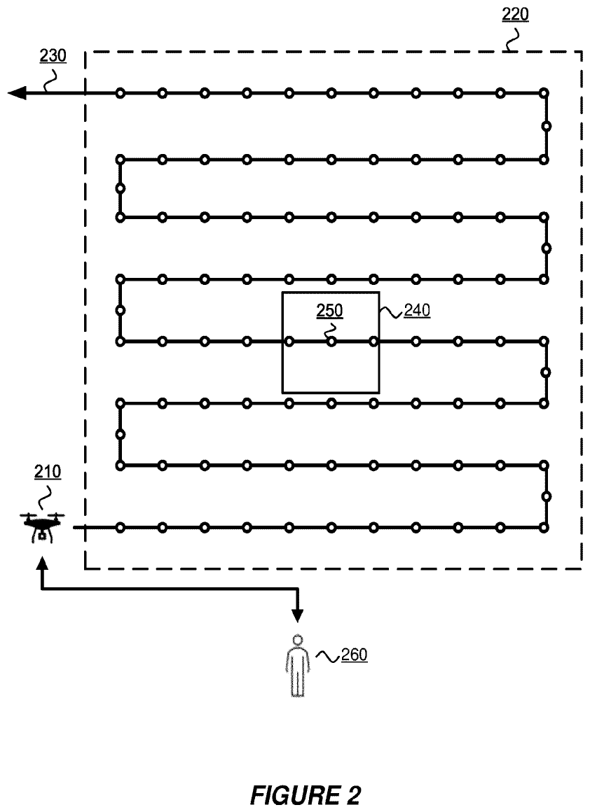

FIG. 2 is a diagrammatic representation of an exemplary scenario in which embodiments of the invention may be used. In this exemplary scenario, an unmanned aerial vehicle (or drone) 210 is to carry out a survey of a geographical area 220. Although the discussion of the invention will be focussed on the use of an unmanned aerial vehicle in such a scenario, it will be appreciated that in some cases vehicles other than an unmanned aerial vehicle may be used, such as an autonomous ground vehicle. Indeed, any mobile entity, may be used including, for example, a satellite. Similarly, other applications of the invention, outside the field of surveying will be apparent to the skilled person.

To carry out the survey, the drone 210 undertakes a journey 230 through the geographical area 220. The unmanned aerial vehicle has one or more sensors on it that are each capable of producing a respective video stream comprising a sequence of images 240 (or frames) taken at various locations 250 as the drone 210 undertakes the journey 230.

Accordingly these video streams provide information about the geographical area 220 during the period of time that the drone 210 is undertaking the journey 230. More specifically, each frame 240 of the video streams that are produced by the one or more sensors provides information about a specific portion of the geographical area 220 that is in the view of the sensor at a specific point in time. The drone 210 records suitable metadata about the video streams in order to allow the specific portion of the geographical area 220 and specific point in time that a frame was captured to be determined. For example, the drone 210 may record positional information to allow the pose (i.e. position and orientation) of the sensor to be determined together with a timestamp of when each frame was captured. The positional information may be obtained from any suitable sensors on the drone, such as from GPS and gyroscope sensors. From the pose of the sensor, the portion of the geographical area that is in its view can be determined.

It is noted that in order to provide a clearer illustration of this scenario, only a single image 240 is represented in FIG. 2 for a single location 250. However, it will be appreciated that in reality a large number of images will be captured at many different locations on the journey 230 to form a video stream. These locations are represented on FIG. 2 by a number of circles along the route 230, even though only a single location has been labelled with a reference sign. Again, it will be appreciated that this is merely illustrative and that in reality the locations at which images are captured on the route are likely to be much more numerous and closer together. Indeed, in most cases, there is likely to be a significant portion of successive frames that overlap and cover largely the same portion of the geographical area 220. Similarly, it will be appreciated that the journey 230 through the geographical area 220 is merely illustrative and that other shape routes may be used in other cases. Furthermore, the route need not provide full coverage of the geographical area 220. In some cases, the drone's 210 journey 230 through the geographical area 220 may provide repeated surveying of at least some of the geographical area 220 (for example, where the drone 210 flies a circular route within the geographical area 220. In such cases, the same video stream may comprise multiple frames 240 covering substantially the same portion of the geographical area 220 at different times, with each such frame being taken on a respective lap of the route performed by the drone 210.

The drone 210 is in communication with one or more operators 260 (or users). The communications between the drone 210 and the one or more operators 260 may be effected using direct communications (such as via a direct wireless link) or indirect communication (such as via a 4G/5G link to a network to which a remote operator is also connected). At least one of the operators 260 is able to control the drone 210. The control of the drone 210 may, in some cases, be real-time control in which the operator controls every aspect of the drone's flight (e.g. lift, velocity, etc.) to cause it to fly a route through the geographical area 220. The control of the drone 210 may, in other cases, be mission-based control in which the operator 260 specifies a mission for the drone 210 to carry out but then leaves the real-time control of the flight to the drone 210. For example, the operator 260 may specify a route for the drone 210 to fly and then leave the drone 210 to control its flight in order to follow that route. As a further example, the operator 260 may specify a geographical area for the drone 210 to survey and then leave the drone 210 to both plan its route through the geographical area 220 in order to carry out the survey as well as controlling its flight in order to follow that route. In some cases, a mixture of real-time and mission-based control may be used. For example, the operator 260 may specify a mission for the drone 210 to carry, but may monitor its flight and intervene, if necessary, by taking real-time control of the drone 210.

The drone 210 is configured to provide survey data to at least one of the operators 260 representing at least some of its findings while carrying out the survey of the geographical area 220. The survey data may comprise the video streams (or portions thereof) from one or more of the sensors on the drone 210. The video streams (or portions thereof) may be provided in raw form (i.e. in substantially the same form as they were captured with minimal post-processing) or in a processed form (e.g. to compress the video stream), or a combination of both. The survey data may also comprise data regarding the details of the journey 230 taken by the drone 210 while carrying out the survey, such as the start time, end time, route taken as well as any other relevant parameters (such as a log of battery status, weather conditions and so on). The survey data (or at least some of the survey data) may be transmitted (e.g. in real-time) whilst the drone 210 is travelling on its journey 230 through the geographical area 220. Additionally or alternatively, the drone 210 may store the survey data on an onboard storage (such as storage 102). The survey data may then be retrieved from the drone 210 at a subsequent point in time, for example, when the drone returns to a recharging point.

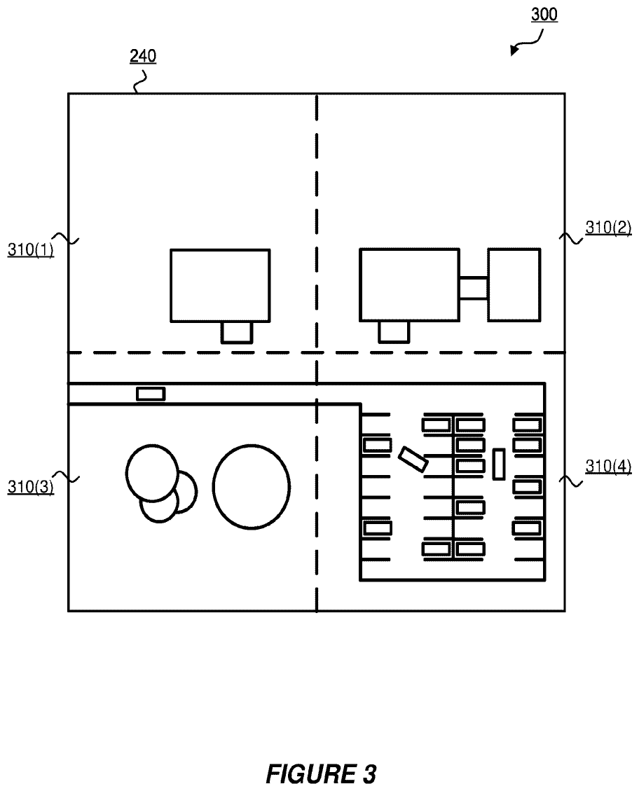

FIG. 3 is a diagrammatic representation of an exemplary frame (or image) 300 of a video stream to be processed by embodiments of the invention. In this example, this frame 300 is the image 240 that was captured at the location 250 in the exemplary scenario illustrated in FIG. 2. In this example, the frame 300 comprises a photograph of the region of the geographic area 220 that was in view of the sensor when the drone 210 was at the location 250. However, as already discussed, in other examples, the frame 300 may comprise any form of image captured by a sensor on board the drone 210 (or indeed mounted on any other type of mobile entity). As will be appreciated, the captured photograph comprising the frame 300 has been simplified for the purposes of diagrammatic representation and explanation of the operation of the invention.

The exemplary frame 300 is divided into four regions 310 (as shown by the dashed lines on FIG. 3). A first region 310(1) covers the top left of the frame 300. A second region 310(2) covers the top right of the frame. A third region 310(3) covers the bottom left of the frame 300. A fourth region 310(4) covers the bottom right of the frame. In this example, a first building is shown in the first region 310(1) of the frame 300, a second building is shown in the second region 310(2), a road with a car on it and various trees are shown in the third region 310(3) and a car park with a number of cars, both moving and parked, are shown in the fourth region 310(4). Discussion of these regions 310 will be continued through the remainder of this description.

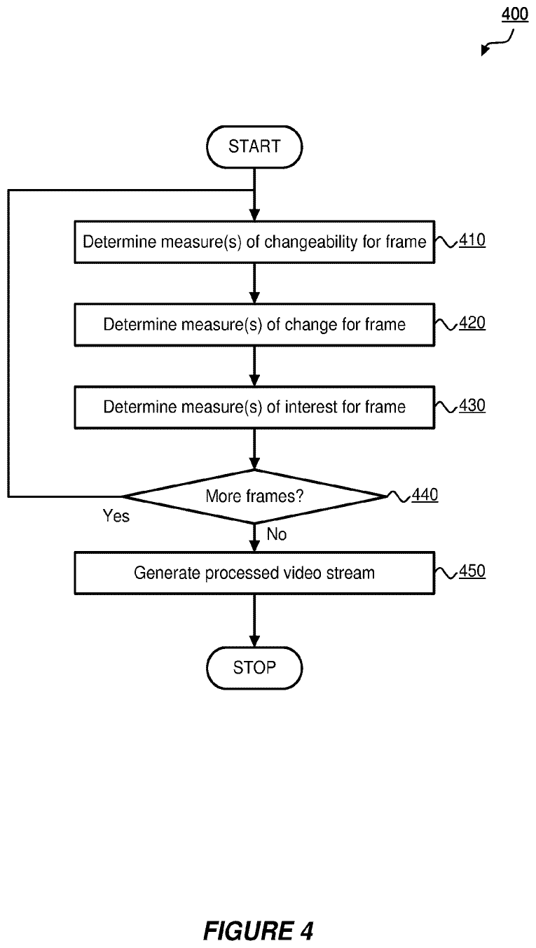

FIG. 4 is a flowchart illustrating a computer-implemented method 400 of processing a video stream captured from a video sensor mounted on a vehicle, such as the unmanned aerial vehicle 210 shown in FIG. 2, during a journey 230 according to embodiments of the invention. The method 400 may be performed by any suitable computer system, such as the computer system 100 described above with reference to FIG. 1. It is generally anticipated that the method 400 will be performed by a computer system onboard the vehicle so that the processed video stream can be stored and/or transmitted such that the available storage and or transmission bandwidth onboard the vehicle can be more optimally used. However, in other cases, the method 400 may be performed by a computer system that is remote from the vehicle. The method 400 starts at an operation 410.

At operation 410, performed in respect of a frame of the video stream, such as the exemplary frame 300 shown in FIG. 3, the method 400 determines one or more measure(s) of changeability for the frame. In particular, a respective measure of changeability is determined for each region of the frame 300. The measure(s) of changeability represent the likelihood that each region of the frame 300 will change over time and are determined from the differences between previously captured frames of (substantially) the same area.

In the example illustrated in FIG. 3, four measure(s) of changeability will be determined, namely: a first measure of changeability being determined for the first region 310(1) of the frame 300; a second measure of changeability being determined for the second region 310(2) of the frame 300; a third measure of changeability being determined for the third region 310(3) of the frame 300; and a fourth measure of changeability being determined for the fourth region 310(4) of the frame. However, in other cases, a different number (either greater or smaller) of regions may be present and a corresponding number of measure(s) of changeability are determined at operation 410. Indeed, in the simplest cases, a single region may be defined for a frame 300 covering the entirety of the frame 300. Accordingly, in such cases, a single measure of changeability may be calculated for the entire frame. However, it is generally anticipated that the frame will be divided into a plurality of regions 310, with a respective measure of changeability being determined for each region.

Where a frame is divided into a plurality of regions this may, in some cases, be done statically. That is to say, each frame may be divided into a predetermined number of regularly shaped equal regions. In this example, each frame is divided into four regions. Of course, a different number of regions may be statically defined in other examples. In other cases, the regions may be dynamically determined which may result in irregularly shaped regions being defined that are specific to each frame. This dynamic determination of the regions will be discussed further below.

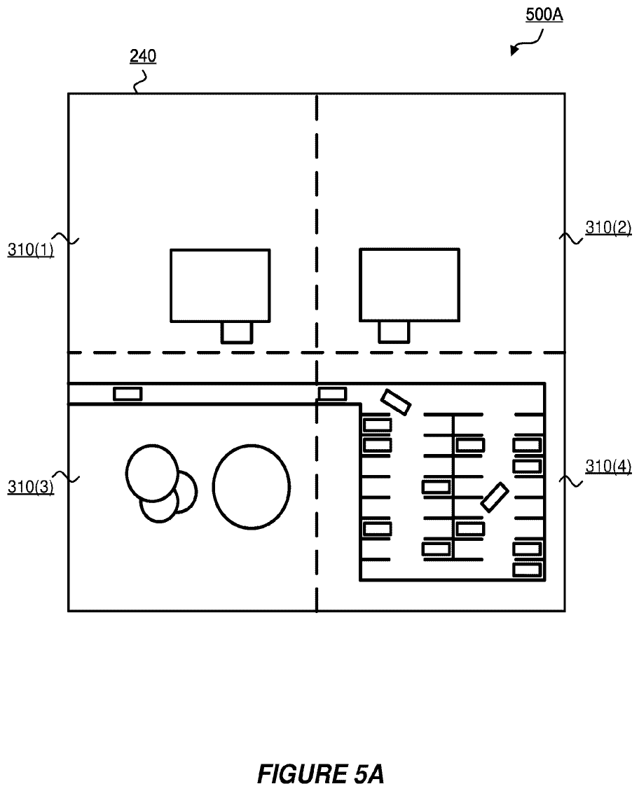

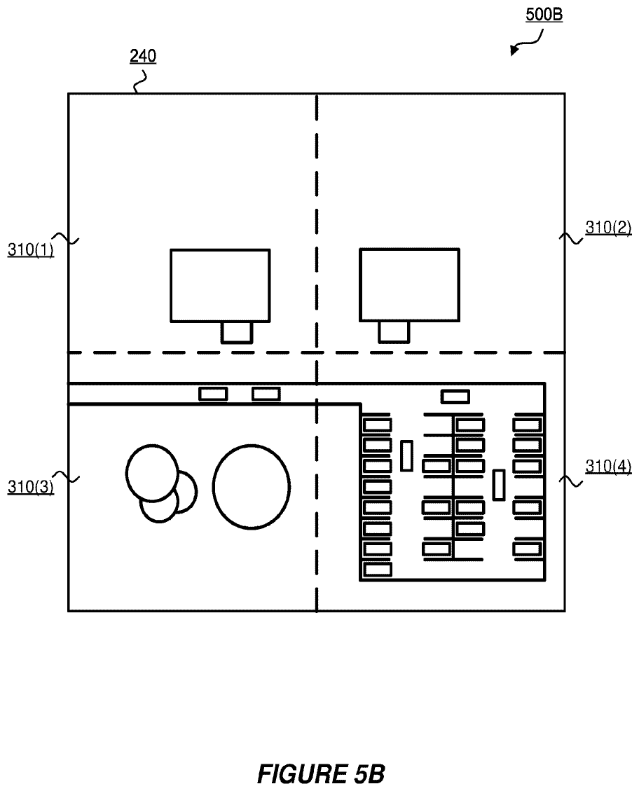

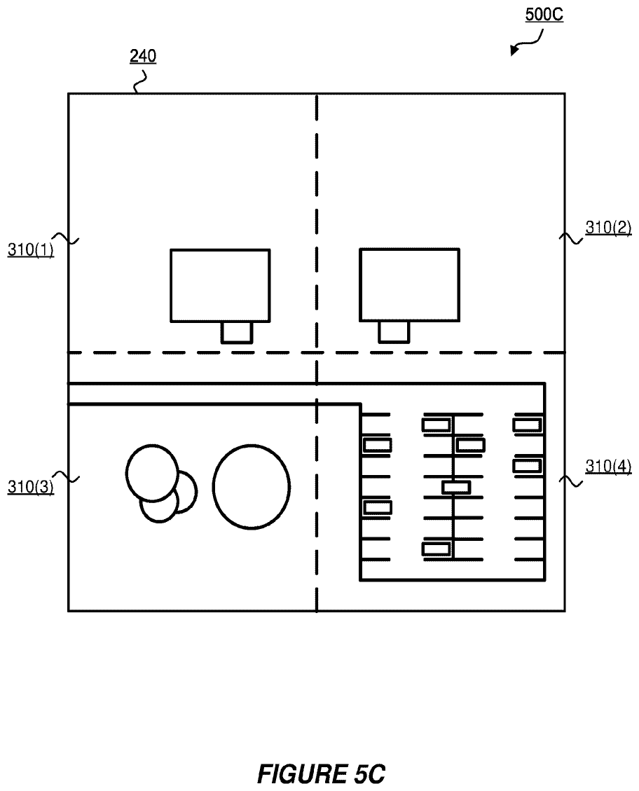

To determine the measure(s) of changeability the method 400 refers to a plurality of reference frames. FIGS. 5A, 5B and 5C are diagrammatic representations of exemplary reference frames 500 for use by embodiments of the invention. Each reference frame 500 covers substantially the same view as the current frame 300 being processed but was captured at a different (earlier) point in time. For example, the reference frames 500 may be extracted from the video streams captured during previous surveys of the geographical area 220 (which may have been carried out by different vehicles, such as different drones 210). In some cases, a reference frame is considered to cover substantially the same view as the current frame when the difference between the area in view for the reference frame and the current frame is less than a predetermined threshold. Of course, the previous surveys need not cover exactly the same geographical area 220 as the current survey (or as each other), nor need they follow the same journey 230, so long as they overlap as far as the view of the current frame (and any other frames for which they are reference images) is concerned. Similarly, the set of reference frames 500 for each frame 300 of the current video stream being processed may be extracted from a different set of previously captured video streams. Additionally or alternatively, one or more or all of the reference frames 500 may be extracted from an earlier portion of the video stream that captured the same area as the current frame at an earlier point during the survey.

The measure(s) of changeability are determined from the reference frames 500 by analysing the differences between each of the reference frames 500 to identify the variability within each region of the frame. Any suitable technique for determining a measure representing this variability may be used. For example, a respective difference between a particular region 310 in each reference frame 500 and the same region 310 in each of the other reference frames may be calculated (e.g. by summing or averaging the pixel differences between those regions 310 of the frames). These differences may then be averaged (e.g. by calculating the mean difference between reference images) to provide the measure of changeability for that region. Accordingly, a higher measure of changeability for a region 310 of a frame indicates that more changes have occurred historically within that region 310 than in regions 310 with a lower measure of changeability.

As will be recognised by those skilled in the art, some degree of pre-processing may need (or be desirable) to be carried out on each reference image prior to determining the measure of changeability. For example, the reference frames 500 may be processed for alignment, transformation (e.g. skewing) and/or photometric normalisation in order to improve the accuracy with which the measure(s) of changeability reflect the true variability between reference frames 500.

As mentioned above, in some cases, the regions 310 of the frame may be dynamically determined. Specifically, the regions 310 of the frame may be determined from the reference frames 500 themselves. One approach to achieving this is to initially analyse the frame on a pixel by pixel basis (or using other small regions of the frame) to determine a measure of changeability for each pixel. Various machine learning techniques, such as clustering may then be used to group together pixels that have similar measures of changeability. In doing so, the method 400 may learn over time what areas of each frame (and therefore of the overall geographical area 220) have a high degree of changeability and what areas of each frame have a low degree of changeability. An alternative approach is to use a neural network to learn the common features of the images, these features may then be used as the regions of the frame. For example, such a neural network may learn that the road shown in the exemplary reference frames is a feature and may therefore define the road as being one of the regions of the frame for which a measure of changeability should be determined.

Turning to the exemplary reference frames 500 illustrated in FIGS. 5A, 5B and 5C, it can be seen that a low measure of changeability may be determined at operation 410 for the first region 310(1) of the frame because the region is essentially unchanged across each of the reference images 500. Similarly, a low measure of changeability may be determined at operation 410 for the second region 310(2) of the frame because this region is also essentially unchanged across each of the reference images 500. A slightly higher measure (e.g. medium level) of changeability may be determined for the third region 310(3) of the frame because this region includes a road that changes slightly between each of the reference frames 500. Finally, a high measure of changeability may be determined for the fourth region 310(4) of the frame because this region includes the car park which changes greatly between each of the reference frames 500.

Having determined respective measure(s) of changeability for one or more regions 310 of the frame 300 at operation 410, the method 400 proceeds to an operation 420.

At operation 420, the method 400 determines a respective measure(s) of change for each of the one or more regions 310 of the frame 300 being processed and at least one of the reference frames 500. That is, whereas the measure(s) of changeability for each of the one or more regions 310 of the frame 300 being processed are determined (at operation 410) exclusively from the historical reference frames 500, the measure(s) of change are determined between the current frame 300 and (at least some of) the historical reference frames 500.

The selection of a suitable reference frame 500 against which to compare the current frame 300 being processed may vary depending on the application to which the invention is being utilised. That is to say, the nature of the change that is being monitored for may dictate which of the reference frames 500 is selected for comparison to the current frame. In some cases, for example, linear changes may be of interest, in which case a most recent of the reference frames 500 may be selected to determine the measure(s) of change for the current frame 300. In other cases, cyclical changes may be of interest, in which case a reference frame 500 that is closest to the same point in the cycle of interest may be selected for determining the measure(s) of change for the current frame 300. For example, where a daily cycle is of interest, the reference frame 500 that was captured closest to the same time of day that the current frame 300 was captured may be selected. Similarly, where a weekly cycle is of interest, the reference frame 500 that was captured at the closest time on the same day of the week as the current frame 300 may be selected. In yet other cases, multiple reference frames 500 may be combined (for example by taking an average of each pixel value) to create a composite reference frame and the measure(s) of change for the current frame 300 may be determined by comparison to the composite reference frame. In still other cases, the reference frames 500 may be used to generate a model of the area being surveyed. A generated reference frame may then be created from the model of the area.

Any suitable technique for determining a measure representing the change between the one or more regions of the current frame 300 and the corresponding regions of the selected reference frame 500 (or composite or generated reference frame as appropriate) may be used. Ideally, to ensure consistency between the different measures, the technique for determining the measure of change is similar to the technique for determining the measure of changeability used in operation 410. For example, the pixel differences between the pixels in each region 310 of the current frame 300 and the corresponding pixels in the reference frame 500 may be summed (or alternatively averaged) to provide the measure of change for that region. As will be appreciated, it should be ensured that the positive pixel differences between pixels do not get cancelled out by the negative differences between pixels. Accordingly, the absolute differences may be used for determining the measure of change. Alternatively, the square of the differences may be summed instead. Accordingly, by calculating the measure of change in such a way, a higher measure of change for a region indicates that there are greater differences between that region of the current frame 300 and the corresponding region of the selected reference frame 500 (or composite or generated reference frame as appropriate).

In a similar manner to that discussed above in relation to the preceding operation 410 of the method 400, it will be appreciated that some degree of pre-processing may be carried out on the frames being compared at operation 420 (e.g. to ensure alignment, transform the images to adjust for any differences and/or photometric normalisation).

Turning to the processing of the exemplary frame 300 illustrated in FIG. 3, the first reference image 500A may be selected as the reference frame 500 against which the changes should be determined. Accordingly, a low measure of change may be determined for the first region 310(1) of the frame 300 as this is unchanged compared to the corresponding region of the first reference frame 500A. However, a high measure of change may be determined for the second region 310(2) of the frame 300 as the building represented in this region of the frame appears to have been extended (and thereby a significant portion of this region has changed) compared to the corresponding region of the first reference frame 500A. The measure of change for the third region 310(3) of the frame 300 may be medium as the only changes relate to the road and so are comparatively small with the majority of the region being unchanged compared to the corresponding region of the first reference frame 500A. Finally, the measure of change for the fourth region 310(4) of the frame 300 may be relatively high (possibly even higher than that for the second region 310(2)) as this region includes lots of changes in the positions of the various cars in the car park.

Having determined respective measure(s) of change for one or more regions 310 of the frame 300 at operation 420, the method 400 proceeds to an operation 430.

At operation 430, the method 400 determines a respective measure of interest for each of the one or more regions 310 of the frame 300. The measure of interest for each region 310 of the frame 300 is determined based on the respective measure of change for the frame that was determined at operation 420 and the respective measure of changeability for the frame that was determined at operation 410. The measure(s) of interest reflect the relative changes in the different regions 310 of the frame 300. That is, how typical the magnitude of the change in a particular region 310 of the frame 300 is. The more atypical the magnitude of change for a particular region 310 of the frame, the higher the measure of interest for that region 310 may be. As an example, the measure of interest for a region 310 of the frame 300 may be determined by dividing the measure of change for the region by the measure of changeability. However, any suitable technique for determining a relative change in the region given its typical changeability (as determined from the reference frames 500) may be used.

Returning again to the processing of the exemplary frame 300 illustrated in FIG. 3, the measure of interest for the first region 310(1) of the frame may be low as the measure of change is low, resulting in a low relative change even though the changeability of this region is also low. By contrast, the measure of interest for the second region 310(2) of the frame 300 is high. This is because not only was a relatively high measure of change determined for this region, but its changeability was also determined to be low meaning that the relative change for this region is very high. The measure of interest for the third region 310(3) of the frame 300 is low because even though a medium measure of change was determined, the changeability of this region is also medium, meaning that the relative change is relatively low (as this level of change is expected for this region 310 of the frame). Finally, the measure of interest for the fourth region 310(4) may also be relatively low. This is because, although the measure of change for this region was fairly high (possibly higher than for the second region 310(2)), the determined changeability of this region is also high and so the relative change is relatively low (again, this level of change doesn't go beyond that expected for this region 310 of the frame).

Although in the illustrated example, a high measure of interest is determined for those regions where the respective measure of change is relatively high compared to the respective measure of changeability, it will be appreciated that in some applications the measure of interest may be configured to select different regions of interest. That is to say, whereas in the illustrated example, the regions of interest are those having a relatively high level of change (compared to that historically observed, as indicated by the measure of changeability), in other applications the regions of interest may be those having a relatively low level of change (compared to that historically observed). In other words, in such applications, a high measure of interest may be determined for those regions where the respective measure of change is relatively low compared to the respective measure of changeability. Indeed, in yet other cases, the regions of interest may simply be any region having an atypical relative amount of change whether higher or lower than normal. In such cases, a high measure of interest may be indicated for those areas with a highly atypical amount of change (e.g. regions with a high measure of changeability and a low measure of change or a low measure of changeability and a high measure of change), whilst a low measure of interest may be indicated for those regions with a fairly typical amount of change (e.g. regions with a high measure of changeability and a high measure of change or a low measure of changeability and a low measure of change).

Having determined respective measure(s) of interest for each region of the frame 300, the method 400 proceeds to an operation 440.

At operation 440, the method 400 determines whether there are more frames in the video stream that need to be processed. If so, the method returns to operation 410 to reiterate operations 410, 420 and 430 in respect of additional frames of the video stream. Otherwise, the method 400 proceeds to an operation 450.

At operation 450, the method 400 generates a processed video stream by processing the video stream according to the determined measure(s) of interest for each frame. In general, it is anticipated that the goal of processing the video stream is to reduce the data requirements for storing and/or transmitting the video stream to an operator 260. That is to say, the goal is to produce a processed video stream that uses less data than the video stream. This can generally be achieved through the removal of irrelevant (or less relevant) parts of the video stream. That is those that have a low measure of interest compared to the rest of the video stream.

In some cases, the processing of the video stream involves dropping one or more frames from the video stream, such that those frames are not included in the processed video stream that is provided to the operator 260. In particular, any frames for which all of the determined measure(s) of interest are lower than (or equal to) a predetermined threshold may be dropped. As a result, the processed video stream will be smaller (i.e. require less data) than the original video stream. As an alternative to specifying a predetermined threshold for dropping frames from the video stream, in some cases, a determination may be made as to how many frames would need to be dropped from the video stream in order to produce a processed video stream of a predetermined size. In such cases, the frames may be ranked in order of the maximum measure of interest for any region within each frame and the determined number of frames having the lowest maximum measure of interest may be dropped from the video stream in order to provide the predetermined size of processed video stream.

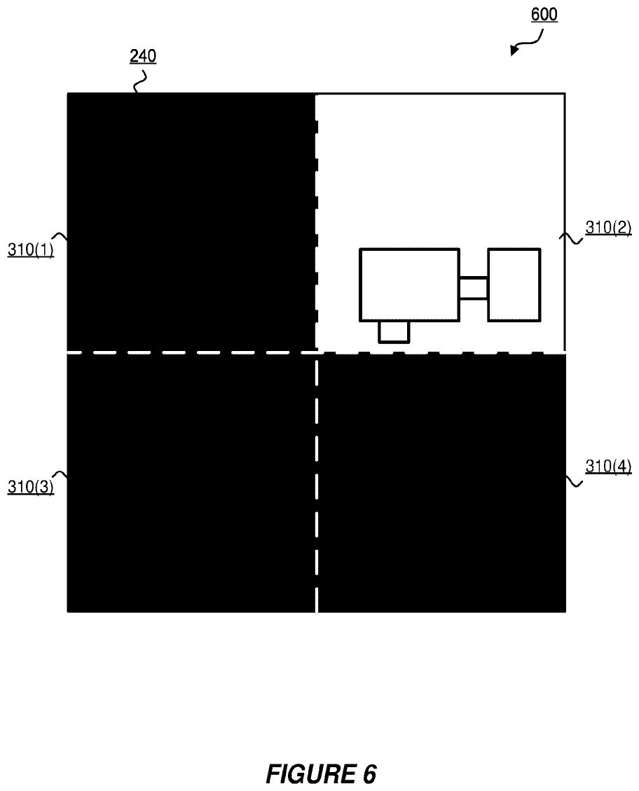

In some cases, the processing of the video stream may additionally or alternatively involve dropping one or more regions from one or more frames of the video stream, such that data representing the images contained on those regions of those frames is not included in the processed video stream. In particular, any regions of each frame that have a respective measure of interest that is lower than (or equal to) a predetermined threshold may be dropped. In this case, the dropping of a region of a frame may be achieved by setting all of the pixel values to a specific value, such as black, which can be compressed more efficiently than the variable data that was previously present in that region. Accordingly, the processed video stream may only comprise data for those regions of each frame that have a corresponding measure of interest that exceeds the predetermined threshold. FIG. 6 is a diagrammatic representation of a processed frame 600 produced from the exemplary frame 300 shown in FIG. 3 using this technique. As can be seen, in the processed frame 600 shown in FIG. 6, the first, third and fourth regions 310(1), 310(3) and 310(4) of the frame 300 have been dropped (as the measure of interest for each of these regions was determined to be relatively low and therefore does not exceed the predetermined threshold). These regions have therefore had each of their pixel values set to a specific value (e.g. black) that will compress efficiently. This leaves the second region 310(2) as the sole remaining region in the processed frame 600. Again, as an alternative to the use of a predetermined threshold for this approach, in some cases, the threshold may be dynamically adjusted in order to produce a processed video stream of a predetermined size. For example, the threshold may be incrementally adjusted until the size of the processed video stream that is produced is less than the predetermined threshold.

In processing the video stream to remove entire frames or regions thereof, as described above, the method 400 may further generate reconstruction data for the processed video stream. This reconstruction data provides an indication to the receiver of the processed video stream as to how to regenerate (or reconstruct) a representation of the dropped frames and/or dropped regions of frames from the plurality of reference frames. For example, the reconstruction data may indicate for each dropped frame and/or each dropped region of a frame a respective corresponding frame or region of a frame of a reference frame 500 that is a closest match. Alternatively, the reconstruction data may indicate how to combine multiple reference frames together to produce a suitable representation of a particular frame or region of a frame that has been dropped from the video stream. This reconstruction data may be provided together with the video stream. Accordingly, a receiver of the processed video stream is able refer to the reconstruction data to generate a suitable image to use in place of the missing frames and/or regions of frames in the processed video stream, thereby enabling a complete video stream to be presented to an operator 260 that includes all the most relevant data from the original video stream. For example, the processed frame 600 shown in FIG. 6 may be accompanied by reconstruction data indicating that representations for the dropped regions 310(1), 310(3) and 310(4) of the frame 600 can be reconstructed using the first reference frame 500A illustrated in FIG. 5A which are similar. Accordingly, the receiver may substitute the images in the first, third and fourth regions 310(1), 310(3) and 310(4) from the first reference frame 500A for the dropped regions of the processed frame 600 in order to reconstruct a complete frame.

In some cases, reconstruction data may additionally be generated for those parts of the video stream that are kept in the processed video stream (e.g. those frames and/or regions of frames for which the respective measure of interest exceeds the predetermined threshold). This is produced in the same way as described above for those parts of the video stream that are dropped. The provision of reconstruction data for those parts of the video stream that are kept in the processed video stream enables a difference image to be used in the processed video steam for those parts of the video stream that are kept. This difference image includes differential data between a frame or region of a frame that is being kept and the representation that would be produced using the reconstruction data.

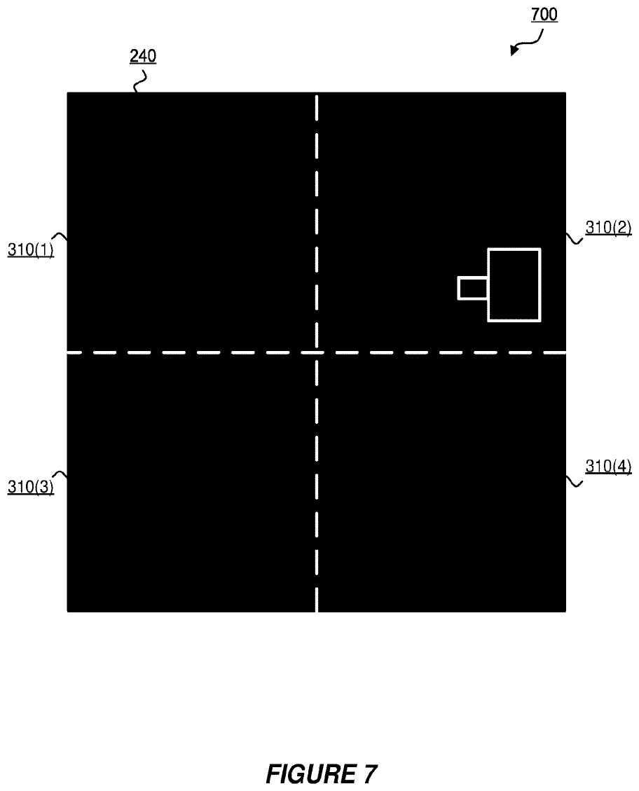

Accordingly, the receiver is enabled to reproduce a frame by generating a representation of the frame using the reconstruction data and applying the differential data included in the processed video stream to it. As will be appreciated, the amount of data needed for the differential data is generally less than that which would be required for the complete data of the frames and/or regions of frames that are to be kept. FIG. 7 is a diagrammatic representation of a processed frame 700 produced from the exemplary frame 300 shown in FIG. 3 using this technique. As can be seen, in the processed frame 700, the first, third and fourth regions 310(1), 310(3) and 310(4) of the frame 300 have been dropped in the same manner as for the processed frame 600 illustrated in FIG. 6. However, in addition to the dropping of these regions of the frame, the second region 310(2) of the frame has been replaced with a difference image between the captured frame 300 and the first reference frame 500A which is to be used to reconstruct that region of the frame. Accordingly, the image in this region 310(2) of the processed frame 700 only contains data for the extension to the building shown in the same region 310(2) of the first reference frame 500A since this is the difference in that region between the two frames.

As an alternative to the provision of reconstruction data, in some cases, the drone 210 and the operator 260 may share a model of the geographical area 220 being surveyed. This model may be generated from the reference frames and may be used to generate images of different areas of the geographical area 220. Accordingly, any differential images may be generated with respect to an image of area produced from the model. Similarly, the model may be used by a receiver of a processed video stream to generate images to substitute for the dropped frames and/or regions of frames and from which to generate images from the differential images provided in the processed video stream (in cases where differential imaging is used).

The above-described uses of reconstruction data (or a shared model) provide means by which a video stream from a mobile entity, such as an unmanned aerial vehicle, can be compressed. Conventional compression techniques can be ineffective in scenarios involving video streams for mobile entities such as drones. This is because such techniques typically rely on sending differences between subsequent frames of the same video stream. However, because drones are constantly moving, significant parts of each frame will tend to change relative to previous frames. Embodiments of the invention overcome this issue by using previously captured frames of the same area (e.g. from the video stream of an earlier survey) rather than subsequent frames in the same video stream.

In some cases, the processed video stream produced by the method 400 may be a consolidated video stream that is produced from a plurality of contemporaneously captured video streams. That is to say, where the drone 210 includes a plurality of sensors each of which simultaneously captures its own respective video stream during the drone's journey 230 through the geographical area 220, each of the video streams may be processed according to operations 410, 420 and 430 to determine respective measure(s) of interest for each frame of each of the video streams. A consolidated video stream may then be produced, at operation 450, by selecting a frame from amongst the contemporaneously captured frames of each of the video streams to be included in the consolidated video stream. This selection may be based on the measure(s) of interest that have been determined for each of the contemporaneously captured frames. For example, the frame that is associated with the highest measure of interest may be selected for inclusion in the consolidated video stream. Alternatively, the frame for which the average measure of interest across all regions of the frame is highest may be selected for inclusion in the consolidated video stream.

Whilst the above described processing techniques are aimed at reducing the size of the processed video stream, it will be appreciated that in some cases the invention may be employed to improve the efficiency of analysis of the video stream without necessarily reducing its data requirements. For example, metadata may be provided as part of the processed video stream (or together with it) to indicate the most relevant parts of the video stream to the operator 260. This can enable the operator 260 to skip to those parts of the video stream that are relevant, thereby saving the time that would be needed to review less relevant parts of the video stream. For example, the metadata may indicate the measures of interest for each region of each frame, allowing the operator to filter the video stream as desired. In such embodiments, the processing of the video stream through the use of method 400 may equally be performed on a computer system that is remote from the drone 210.

Insofar as embodiments of the invention described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present invention. The computer program may be embodied as source code or undergo compilation for implementation on a processing device, apparatus or system or may be embodied as object code, for example. Suitably, the computer program is stored on a carrier medium in machine or device readable form, for example in solid-state memory, magnetic memory such as disk or tape, optically or magneto-optically readable memory such as compact disk or digital versatile disk etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention. It will be understood by those skilled in the art that, although the present invention has been described in relation to the above-described example embodiments, the invention is not limited thereto and that there are many possible variations and modifications which fall within the scope of the invention. The scope of the present invention includes any novel features or combination of features disclosed herein.

The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer-implemented method of processing a video stream captured from a video sensor mounted on a mobile entity during a journey, the method comprising, for each frame of the video stream:
determining a respective measure of changeability for one or more regions of the frame based on a plurality of reference frames, each of the plurality of reference frames being a previously captured frame covering substantially the same view as the frame;
determining a respective measure of change for each of the one or more regions of the frame, the measure of change being determined based on the frame and at least one of the reference frames;
determining a respective measure of interest for each of the one or more regions of the frame, the respective measure of interest being based on the respective measure of change and the respective measure of changeability for that frame; and
processing the video stream based on the determined measures of interest for each frame to generate a processed video stream.

2. The method of claim 1, wherein processing the video stream comprises, for each frame of the video stream:
determining whether the respective measures of interest for any of the one or more regions of that frame exceeds a predetermined threshold; and
dropping that frame from the processed video stream in response to determining that none of the respective measures of interest for the one or more regions of the frame exceeds the predetermined threshold.

3. The method of claim 1, wherein processing the video stream comprises, for each frame of the video stream:
determining whether the respective measure of interest for each of the one or more regions of the frame exceeds a predetermined threshold; and
in response to determining that the respective measure of interest for a region of the frame does not exceed the predetermined threshold, dropping that region of the frame, such that the corresponding frame of the processed video stream only comprises those regions of the frame for which the respective measure of interest exceeds the predetermined threshold.

4. The method of claim 3, wherein the method further comprises:
generating, for each region of the frame for which the respective measure of interest does not exceed the predetermined threshold, respective reconstruction data for reconstructing a representation of that region of the frame from the plurality of reference frames; and
providing the respective reconstruction data with the processed video stream.

5. The method of claim 2, wherein processing the video stream further comprises, for each frame of the video stream, in response to determining that the respective measure of interest for a region of the frame exceeds the predetermined threshold:
generating respective reconstruction data for reconstructing a representation of that region of the frame from the plurality of reference frames;
determining a difference image for that region of the frame representing the difference between that region of the frame and the representation of that region of the frame provided by the reconstruction data;
substituting that region of the frame in the processed video stream with the difference image; and
providing the respective reconstruction data with the processed video stream.

6. The method of claim 5, wherein the frame reconstruction data comprises an indication of one of the reference frames for which the corresponding region most closely matches that region of the frame.

7. The method of claim 4, wherein the frame reconstruction data indicates a combination of at least two reference frames.

8. A computer-implemented method of processing a plurality of video streams, each video stream being contemporaneously captured from a respective video sensor mounted on a mobile entity, the method comprising:
processing each of the plurality of video streams according to the method of claim 1; and
producing, as the processed video stream for the plurality of video streams, a consolidated video stream from the plurality of video streams by selecting, for each frame of the consolidated video stream, a single frame from contemporaneously captured frames of the plurality of video streams based on the respective measures of interest for each of those frames.

9. The method of claim 1, further comprising storing the processed video stream on a storage onboard the mobile entity.

10. The method of claim 1, further comprising transmitting the processed video stream to a remote receiver.

11. The method of claim 1, wherein the mobile entity is a vehicle, preferably wherein the vehicle is an unmanned aerial vehicle.

12. The method of claim 1, wherein the mobile entity is a satellite.

13. The method of claim 1, wherein the journey is undertaken as part of a survey of a geographical area and preferably wherein one or more, or all, of the reference frames are each associated with a respective video stream that was captured from a previous survey of the geographical area.

14. A computer system comprising a processor and a memory storing computer program code for performing the steps of claim 1.

15. A computer program which, when executed by one or more processors is arranged to carry out a method according to claim 1.
